(19) United States
(12) Patent Application Publication
(10) Pub. No.: US 2010/0235587 A1
(43) Pub. Date: Sep. 16, 2010

(54) Staged Software Transactional Memory

(75) Inventor: Cyprien NOEL, New York, NY (US)

Correspondence Address: Argilsoft LLC, 40 Harrison Street, #30 G, New York, NY, 10013, US

(73) Assignee: ARGILSOFT LLC, New York, NY (US)

(21) Appl. No.: 12/404,351

(22) Filed: Mar. 16, 2009

(51) Int. Cl. G06F 12/00; G06F 12/14

(52) U.S. Cl. 711/147; 711/E12.001; 718/101; 711/163; 711/E12.091

(57) ABSTRACT

A new form of software transactional memory based on maps for which data goes through three stages. Updates to shared memory are first redirected to a transaction-private map which associates each updated memory location with its transaction-private value. Maps are then added to a shared queue so that multiple versions of memory can be used concurrently by running transactions. Maps are later removed from the queue when the updates they refer to have been applied to the corresponding memory locations. This design offers a very simple semantic where starting a transaction takes a stable snapshot of all transactional objects in memory. It prevents transactions from aborting or seeing inconsistent data in case of conflict. Performance is interesting for long running transactions as no synchronization is needed between a transaction's start and commit, which can themselves be lock free.

### BACKGROUND OF THE INVENTION

New programming models are explored throughout the software industry to simplify concurrent programming and take advantage of multi and future many core machines. Transactional memories leverage the concept of transaction familiar to the database community to automatically isolate concurrent in-memory operations. Software based implementations are particularly interesting as they can be used on today's hardware.

A very complete review of software transactional memory implementations has been written by James R. Larus and Ravi Rajwar in 2007 called Transactional Memory. Other interesting implementations which are not part of this review include Closure, a functional language which stores mutable state in an STM, and JVSTM by João Cachopo and Antònio Rito-Silva. Those two STM are similar to this design as they feature Multi Version Concurrency Control (MVSCC).

All those STMs have in common to store transaction related data like ownership descriptors, locks or object versions in the transactional objects or structures themselves. Those objects or structures can be read or written by another transaction or by non transactional code anytime. This implies that code running in the context of a transaction manipulate shared state.

The issue with manipulating shared state is that any read or write needs to be synchronized with other threads' reads and writes. Some STM implementations protect those accesses by using locks on shared data structures, others in a lock free way, but in any case reading and write to shared state requires some form of synchronization. For code running on the Java Virtual Machine or the Common Language Runtime for example, the memory model mandates that shared reads and writes that are not protected by a lock be annotated as “volatile”. During compilation to native code, those memory accesses are protected using memory fences on most hardware and are much more expensive and less scalable than usual memory accesses.

In our design we made the choice to accept additional overhead in terms of computation and memory requirement compared to other implementations in return for not manipulating shared state during the execution of a transaction. Lock free synchronization primitives like memory fences and compare and swaps are still needed to start a transaction and to commit or abort it.

### BRIEF DESCRIPTION OF THE DRAWINGS

FIG. 1, two transactions with their private map referencing transaction-private object versions.

FIG. 2, active transactions counter on maps.

FIG. 3, updates go through three stages: transaction-private, queued and in transactional objects.

FIG. 4, the whole lifecycle of a transaction: reading shared queue and incrementing map's transactions counter, creating transaction-private versions, replacing the queue, and decrementing the counter.

### IMPLEMENTATION

The preferred embodiment described below is object oriented, but the scope of this invention is not limited to this paradigm. In this description memory is referred to as objects, memory updates as objects' state updates, and a new value for a memory location is modeled as an object version. An object version is an object which contains a new value for one or more fields of a parent object. The public API to update a location of the transactional memory is modeled as transactional objects, i.e. objects whose state can be modified in a transactional way.

The main focus of this design is to remove shared state manipulation to avoid synchronization. This is done by making transactions self contained and shared state immutable. Self contained means that state which is private to a transaction is only referenced by the transaction itself, not by shared objects. It ensures that this state can only be manipulated by the thread running the transaction. As soon as a transaction commits, its private state becomes shared and accessible to other threads. It must not be modified anymore so it can be seen as immutable and be safe to read by other threads, still without synchronization.

To achieve this in practice, data stored in this transactional memory goes though three stages:

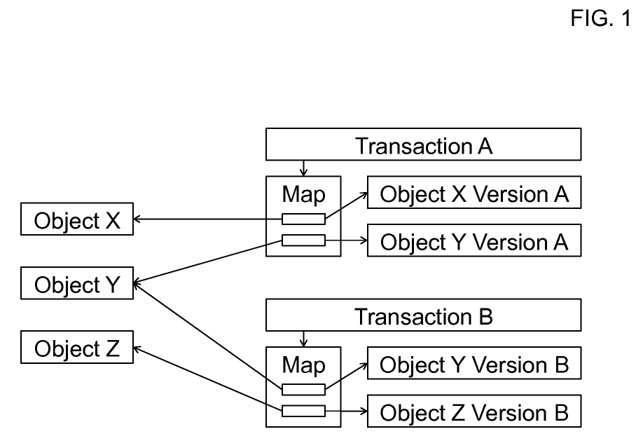

1. To modify a transactional object, a transaction first creates a new object version for it and stores it in a map with the transactional object as a key (FIG. 1). As long as the transaction is not committed, this map and the versions it references are transaction-private and can be accessed and updated without synchronization.

2. On commit, the transaction adds its map to a shared queue of maps. The point of this queue is to allow a transaction to make its updates visible without immediately modifying transactional objects. When a transaction starts it references the queue and record which map was the last one when it started. Queued maps do not change and subsequent writes to memory will be added further away in the queue so this map can be used as an immutable memory snapshot. The process of searching in the queue for the latest value of an object is detailed later.

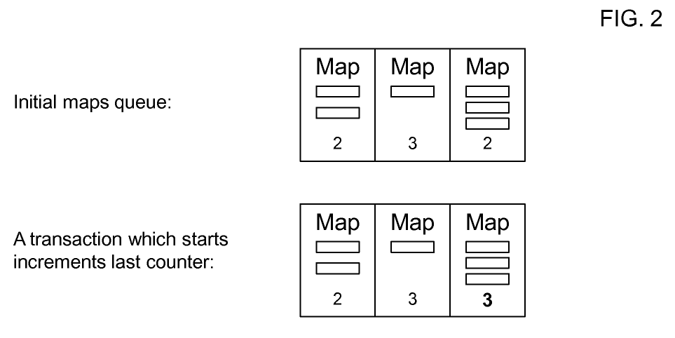

3. When all transactions using a particular map as their memory snapshot are committed or aborted, it can be removed from the queue. In our implementation this is determined using a counter of active transactions on each map which is atomically incremented when a transaction starts (FIG. 2) and decremented when it commits or aborts. Before the map is removed, each update it contains is either applied to the transactional object if it was the first of the queue, or merged to the next map in the queue. Applying the updates or merging two maps together does not change the memory snapshot seen by running transactions.

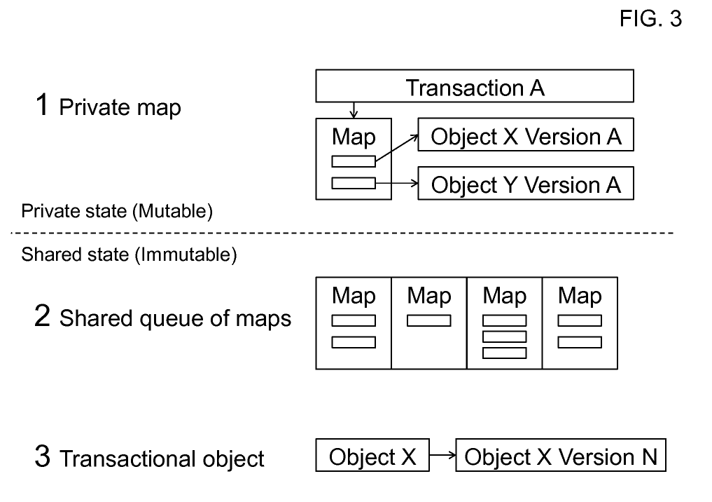

FIG. 3 summarizes the three stages underwent by data written to this memory as it flows from transactions to the queue and then to transactional objects.

Reading a value follows a similar process, transactions start searching for a version of an object in their private map. If no appropriate version is found, the queue is walked in reverse order, starting by the map which was last when the transaction started. If no version is found, the shared version referenced by the transactional object itself is used. This ensures a transaction always sees the latest version of an object, but only if it was created before transaction started.

Conflict detection is done when a transaction adds its map to the queue. It first creates a new instance of the queue containing its private map, then tries to replace the existing queue with a compare and swap. If the compare and swap fails, it means another transaction committed in the meantime. It then needs to read the new queue, find the position of the map it is using as its memory snapshot and iterate over maps that would have been added after it.

A conflict occurs if any of those new maps contain a version for an object that has been read by our transaction. If no conflict is detected, the transaction can retry the commit. It needs to copy the new maps to its queue and try the compare and swap again. This process can be retried until the compare and swap succeeds or a conflict occurs. If a conflict is indeed detected our implementation aborts the transaction.

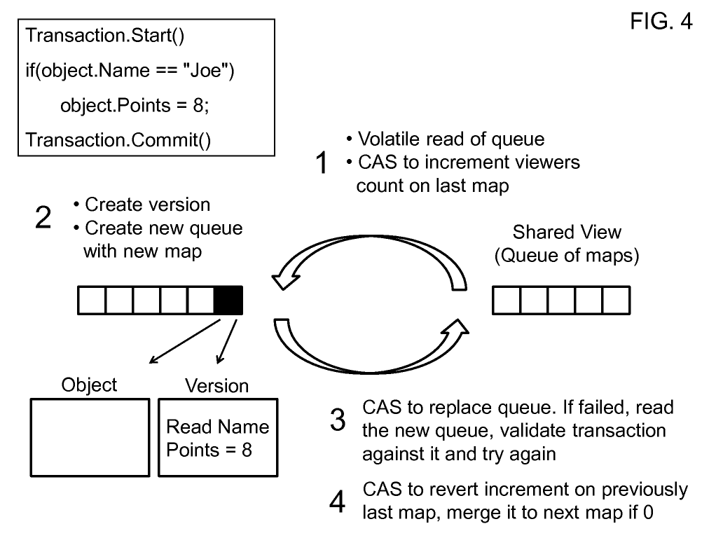

FIG. 4 summarizes the whole lifecycle of a transaction from start to commit.

### Synchronization Remarks

The following elements required particular attention when implementing this method.

When a transaction starts and reads the queue, appropriate memory fences are necessary on some hardware as it might have been updated by other threads. Our implementation relies on a volatile read to ensure this is done correctly. The same remark holds on the writer side when adding a map to the queue so other threads see a consistent view of memory referenced by the new map.

When merging to maps together, data cannot be overridden in any one of them as other transactions can be concurrently searching them for object versions. Our maps implementation uses arrays of object versions so it is possible to merge a map into the empty slots of another one without overriding any data. If a version is written to a map searched concurrently by another thread, the thread will either read null and pick the version in the next map in the queue, or read the version directly, which is equivalent. We rely here on hardware to provide atomicity for pointer wide memory updates.

In case the target array is not large enough to perform the merge directly, a third map is created where both maps are merged. In any case, a new queue is created containing the shrunk set of maps and replaces the previous one using a compare and swap like a transaction commit. This way the modifications done to the maps become visible to other threads in an atomic and consistent way.

Here is a summary of the synchronization needed for each step:

When it starts, a transaction needs to increment the transactions counter on the last map of the queue, which uses at least one CAS, and a memory fence (volatile read in Java or .NET) is needed when referencing the queue.

Commit requires a compare and swap to replace the the queue atomically. Memory fences (volatile write) are needed to publish the new queue correctly to other threads. If the compare and swap fails, another memory fence (volatile read of the latest queue) is needed to read the queue and search for a conflicting object version.

When a transaction is over a compare and swap is used to decrement the counter in its start map, and another one to replace the queue atomically if it has been skunk.

What is claimed is:

1. A computer implemented method, comprising:
while a transaction is running, using a transaction-private map to redirect shared memory updates to transaction-private memory,
when the transaction commits, adding the map to a shared set of maps,
applying the redirected updates to shared memory and removing the map from the set.

2. The method of claim 1, wherein memory is organized as objects in an object oriented language or runtime.

3. The method of claim 1, wherein no step of the method is partially or completely implemented in hardware.

4. The method of claim 1, wherein maps are hash maps.

5. The method of claim 1, wherein adding a new map to the queue is done in a lock free way comprising a compare and swap (CAS).

6. The method of claim 1, wherein a counter is associated to each map to determine when it can safely be removed from the queue.

7. A digital computer system programmed to perform the method of claim 1.

8. A computer-readable medium storing a computer program implementing the method of claim 1.
